(19) United States
(12) Patent Application Publication
(10) Pub. No.: US 2008/0035623 A1
(43) Pub. Date: Feb. 14, 2008

(54) Contact tip and assembly

(75) Inventor: Richard M. Hutchison, Iola, WI (US)

Correspondence Address: FLETCHER YODER (ILLINOIS TOOL WORKS INC.), P.O. BOX 692289, HOUSTON, TX, 77269-2289, US

(73) Assignee: Illinois Tool Works Inc.

(21) Appl. No.: 11/820,633

(22) Filed: Jun. 20, 2007

Related U.S. Application Data
(60) Provisional application No. 60/837,253, filed on Aug. 11, 2006.

(51) Int. Cl. B23K 9/28

(52) U.S. Cl. 219/136

(57) ABSTRACT

A contact tip for a welding torch is provided. In one embodiment, the contact tip includes a body formed of an electrically conductive material and a non-linear passage that extends through the body. The non-linear passage of this embodiment is configured to receive a wire electrode and to facilitate electrical communication between the body and the wire electrode. Various contact tip assemblies and manufacturing techniques for forming contact tips are also provided.

### CROSS-REFERENCE TO RELATED APPLICATIONS

This application claims priority to U.S. Provisional Patent Application No. 60/837,253, entitled “CONTACT TIP AND ASSEMBLY”, filed on Aug. 11, 2006.

### BACKGROUND

The present invention relates generally to welding systems and, particularly, to contact tips and contact tip assemblies of such systems.

A common metal welding technique employs the heat generated by electrical arcing to transition a portion of a workpiece to a molten state, and the addition of filler metal from a wire or electrode. One technique that employs this arcing principle is wire-feed welding. At its essence, wire-feed welding involves routing welding current from a power source into an electrode that is brought into close proximity or contact with the workpiece. When the electrode is sufficiently close to or touching the workpiece, current arcs from the electrode to the workpiece, completing a circuit and generating sufficient heat to melt and weld the workpiece. Often, the electrode is consumed and becomes part of the weld itself. Thus, new wire electrode is advanced, continuously replacing the consumed electrode and maintaining the welding arc. If the welding device is properly adjusted, the wire-feed advancement and arcing cycle progresses smoothly, providing a good weld. One common type of wire-feed welding is metal inert gas or “MIG” welding.

In typical wire-feed systems, wire electrode is directed through a welding cable, into a torch assembly, and, particularly, into a contact tip housed within the torch assembly. Electrical current is routed from the welding cable to the wire electrode through the contact tip. When a trigger on the welding torch is operated, wire electrode is advanced toward the contact tip, at which point current is conducted from the contact tip into the egressing electrode.

Because such welding operations generally involve conduction of electricity through the contact tip to the wire electrode, contact tips generally include an internal, straight bore formed in the contact tip to receive the wire electrode. In such traditional arrangements, electrical current is transmitted to the contact tip, through the body of the contact tip, and to the wire electrode disposed within the internal bore. Unfortunately, such a design may result in minimal contact between the wire electrode and the contact tip, which increases the density of current flowing from the contact tip to the wire electrode. In some cases, these disadvantageous effects may result in inconsistent starting of a welding torch, melting of the wire electrode within the contact tip itself, and increased electrical erosion of the contact tip. As a result, these effects may negatively impact the useful life of the contact tip and require more frequent maintenance or replacement than other components of the welding system.

Therefore, there exists a need for improved contact tip assemblies for welding devices that enhance electrical communication between the contact tip assembly and a wire electrode and increase the longevity of components within such assemblies.

### BRIEF DESCRIPTION

As discussed in detail below, certain embodiments of the present invention may provide a contact tip that includes a non-linear passage for receiving a wire electrode. The non-linear passage may reduce current density passing to the wire electrode, increase the useful operating life of the contact tip, and increase the reliability of welding systems employing such contact tips. In such embodiments, the contact tip includes a non-linear path that may vary in either two-dimensions or three-dimensions, and both the contact tip and the non-linear path may be formed through various techniques. For instance, in one embodiment, the contact tip may be formed of two mating pieces that have complimentary channels that define a non-linear wire path when the pieces are assembled. However, in other embodiments, a contact tip having a non-linear path may be composed of a single, unitary body or more than two mating pieces. In another embodiment, the non-linear wire path may be formed through application of a force, such as that provided by a rolling process, to the exterior of a contact tip in order to alter a linear path into a non-linear path. In other embodiments, a contact tip assembly is provided for securing a contact tip, which may have a linear or non-linear wire path, by applying a radial clamping force to the contact tip.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic representation of a welding system, in accordance with one embodiment of the present invention;

FIG. 2 is a diagrammatic representation of a welding torch assembly for use with the system of FIG. 1, in accordance with one embodiment of the present invention;

FIG. 3 is an exploded view of an exemplary contact tip assembly of the torch assembly shown in FIG. 2, in accordance with one embodiment of the present invention;

FIG. 4 is a cross-sectional representation, taken along line 4-4 of FIG. 2, of the exemplary contact tip assembly illustrated in FIGS. 2 and 3, illustrating passage of an electrode through a non-linear passage of the exemplary contact tip of the assembly;

FIG. 5 is an exploded view of a pair of mating elements that may be combined to form an exemplary contact tip having a non-linear electrode path that varies in at least two dimensions in accordance with one embodiment of the present invention;

FIG. 6 is a top plan view of the exemplary contact tip of FIG. 5, illustrating horizontal variation of the non-linear electrode path in accordance with one embodiment of the present invention;

FIG. 7 is an exploded view of a contact tip assembly in accordance with one embodiment of the present invention; and

FIG. 8 is an elevational view of an exemplary contact tip in accordance with one embodiment of the present invention.

### DETAILED DESCRIPTION

One or more exemplary embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

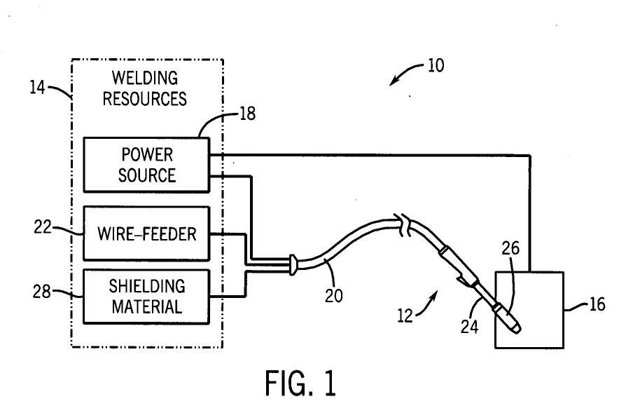

FIG. 1 illustrates an exemplary wire-feed welding system 10 that incorporates a contact tip having a non-linear electrode path, as described in greater detail below. Prior to continuing, however, it should be noted that the following discussion merely relates to exemplary embodiments of the present technique. As such, the appended claims should not be viewed as limited to those embodiments specifically described herein.

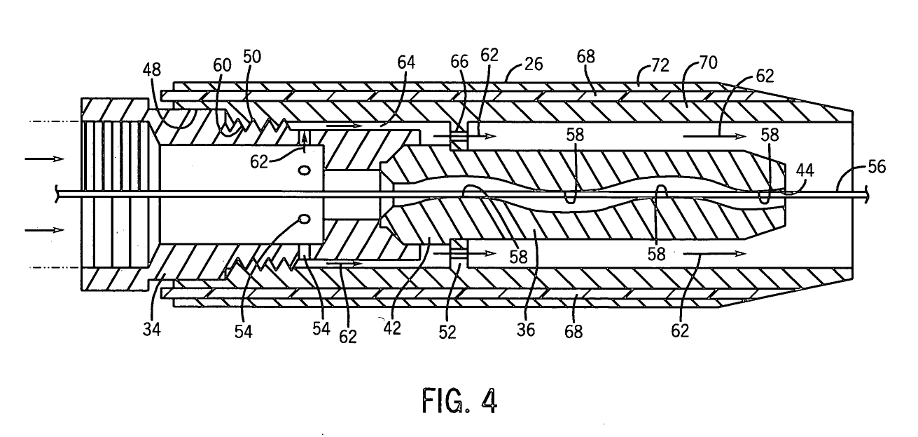

The exemplary welding system 10 includes a welding torch 12 and one or more welding resources 14 that may be utilized to perform a welding operation on a workpiece 16. Placement of the welding torch 12 at a location proximate to the workpiece 16 allows electrical current, which is provided by a power source 18 and routed to the welding torch 12 via a welding cable 20, to arc from the welding torch 12 to the workpiece 16. In summary, this arcing completes an electrical circuit that includes the power source 18, the welding torch 12, and the workpiece 16. Particularly, in one embodiment, current passes from the power source 18, to the welding torch 12 via the welding cable 20, to a wire electrode (see, e.g., FIG. 4), to the workpiece 16, and, at its conclusion, back to the power source 18. This arcing generates a relatively large amount of heat that causes the workpiece 16 and/or filler metal to transition to a molten state, thereby facilitating the weld. As will be appreciated, the filler metal may be provided by the wire electrode or from some other source.

In addition to the power source 18, the welding resources 14 may include a wire feeder 22 that provides a consumable wire electrode, such as wire 56 (FIG. 4), through the welding cable 20 to the welding torch 12. A wide array of wire electrodes may be used in accordance with the present techniques, including traditional wire electrodes or gasless wire electrodes. As discussed further below, in some embodiments, the welding torch 12 conducts electrical current to the wire electrode via a contact tip located in a neck assembly 24 and supported by a securing member or nozzle 26 to facilitate arcing between the egressing wire electrode and the workpiece 16.

To shield the weld area from contaminants during welding, to enhance arc performance, and to improve the resulting weld, the exemplary system 10 includes a shielding material source 28 that feeds an inert, shielding gas to the welding torch 12 via the welding cable 20. It is worth noting, however, that a variety of shielding materials for protecting the weld location may be employed in addition to, or in place of, the inert shielding gas, including active gases, various fluids, and particulate solids. Further, other embodiments, such as those employing gasless wire electrodes, may not greatly benefit from a shielding material and, accordingly, may or may not include the shielding material source 28.

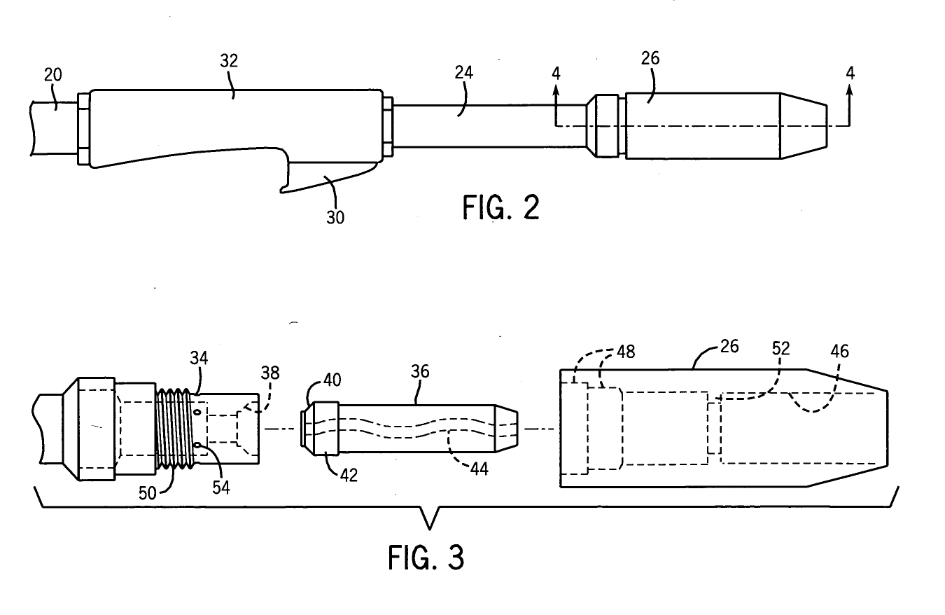

Referring to one embodiment illustrated in FIG. 2, advancement of these welding resources (e.g., welding current, wire electrode, and shielding gas) is effectuated by actuation of a trigger 30 secured to a handle 32 of the welding torch 12. By depressing the trigger 30 of the exemplary welding torch 12, a switch (not shown) disposed within the trigger is closed, causing the transmission of an electrical signal that commands delivery of the welding resources into the welding cable 20 and to the neck assembly 24.

Turning to FIGS. 3 and 4, these figures illustrate an exemplary contact tip assembly of the welding torch 12. Notably, the contact tip assembly includes a diffuser 34, a contact tip 36, and the nozzle 26. In the exemplary welding system, the diffuser 34 operates to receive the welding current, the wire electrode, and the shielding material. A generally conical seating location 38 of the diffuser 34 corresponds with a mating surface 40 of the contact tip 36, thereby facilitating the centering and engagement of the contact tip 36 with the diffuser 34. Such conically shaped diffusers and contact tips are generally described in U.S. Pat. No. 6,852,950 that issued on Feb. 8, 2005, and U.S. Patent Application Publication No. 20040026395 that was published on Feb. 12, 2004, both of which are incorporated herein by reference. However, it should be noted that the use of diffusers and contact tips having other geometries are also envisaged and may be employed in full accordance with the present techniques.

Further, in the presently illustrated embodiment, the nozzle 26 is adapted to receive and secure the contact tip 36 with respect to the diffuser 34. Particularly, the exemplary nozzle 26 includes a central channel or bore 46 for receiving the contact tip 36, and a seating surface 48 for mating engagement with the diffuser 34. In one embodiment, a threaded portion 50 of the diffuser 34 is engaged by mating threads 60 on the seating surface 48. Of course, other mechanisms for mechanically coupling the nozzle 26 with the diffuser 34, such as clamps or friction fit arrangements, are also envisaged. The nozzle 26 may also include an internal shoulder 52 that engages a complimentary shoulder 42 of contact tip 36 upon assembly.

As may be appreciated, the diffuser 34 conducts welding current to the contact tip 36, which passes the current to the egressing wire electrode and, ultimately, to the workpiece 16. To enable such transmission, the diffuser 34 and contact tip 36 are formed of a conductive material, such as copper. To insulate the current-carrying members of the contact tip assembly, the nozzle 26 may include an insulating layer 68 that insulates the exposed external surface 72 from the possibly electrically conductive internal surface 70 of the nozzle 26. Alternatively, the nozzle 26 may be generally formed of an electrically insulating material, such as ceramic, to inhibit conduction of electrical current from the diffuser 34 and contact tip 36 to the exterior of the nozzle 26.

The exemplary contact tip 36 includes a wire path 44 that is non-linear. That is, the course of the wire path 44 is not straight and varies with respect to a linear approximation of the wire path 44. In various embodiments, the non-linear wire path 44 may include a small number of curves or changes in direction, such as a single curve, or may generally define a circuitous or labyrinthine path. It should also be noted that the variation of the non-linear wire path 44 may occur in either two-dimensions or three-dimensions. For instance, in one embodiment the course of the non-linear wire path 44 may generally vary in a single plane, such as a plane containing a longitudinal axis of the contact tip 36. In other embodiments, the non-linear wire path may vary in three dimensions, such as a substantially helical path through the contact tip 36. The exemplary wire path 44 is adapted to receive an electrode, such as wire 56, and the non-linearity of this exemplary path 44 facilitates electrical communication between the contact tip 36 and the wire 56 at contact locations 58. Particularly, the non-linear nature of the exemplary wire path 44 promotes contact of the wire 56 with the contact tip 36 at one or more of various locations 58, and thereby increases the incidence of contact between these elements, increases the surface area of contact between these elements, and reduces the current density at points of contact. Thus, current may be passed more reliably from the contact tip 36 to the wire 56, enabling welding of the workpiece 16 (FIG. 1).

As discussed above, in addition to receiving and transmitting current to the contact tip 36, the exemplary diffuser 34 may also receive a shielding gas from source 28 (FIG. 1). During operation, radially extending channels 54 in the diffuser 34 operate to direct shielding gas around the contact tip 36 and a portion of the wire 56 extending beyond the contact tip 36. The flow of such shielding gas in the present embodiment is generally indicated by the arrows 62. As depicted in FIG. 4, the shielding gas exits the diffuser 34 through the channels 54, is conducted through an interstitial space defined by the interior of nozzle 26 and the exterior of diffuser 34, passes through axial ports 66 of the shoulder 52, and exits about the wire 56 proximate the weld location at an end of the nozzle 26.

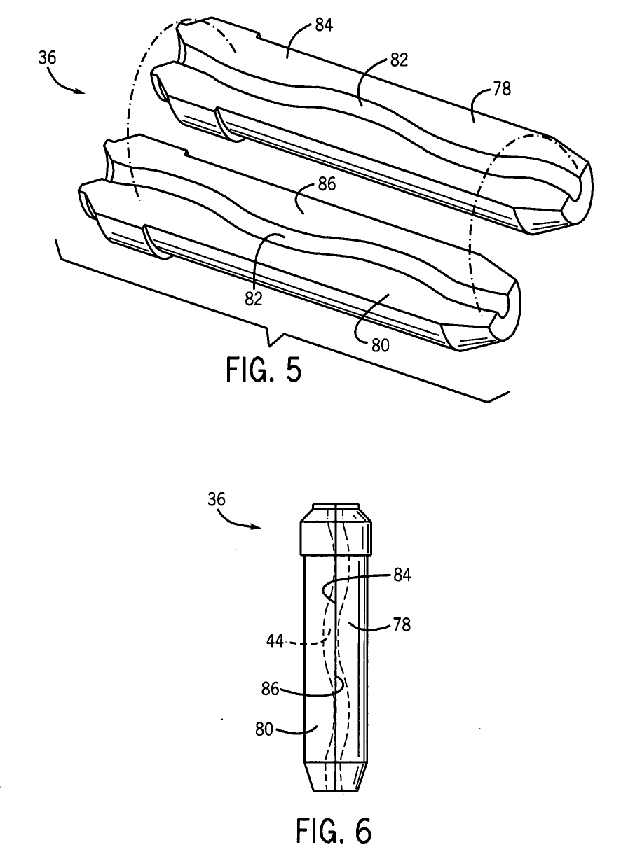

As may be appreciated, the contact tip 36 may be constructed in a number of different shapes, sizes, and configurations through a variety of manufacturing techniques. For instance, in the embodiment illustrated in FIGS. 5 and 6, the contact tip 36 is formed of first and second mating portions 78 and 80. First portion 78 includes a channel 82 formed in a surface 84. Likewise, second portion 80 also includes a channel 82 formed in a mating surface 86. The channels 82 cooperate with one another to form a non-linear wire path 44 when the surfaces 84 and 86 are drawn into engagement with one another, as illustrated in FIG. 6.

The contact tip portions 78 and 80, and the respective channels 82, may be formed through a variety of techniques. For example, the portions 78 and 80 may be formed through one or more manufacturing processes, such as stamping, casting, pressing, machining, or the like. Similarly, the channels 82 may be pressed into the portions 78 and 80, formed through a casting process that may also form the portions 78 and 80, machined into the surfaces 84 and 86, or formed in some other manner. Further, the respective channels 82 of portions 78 and 80 may be substantially constant in depth to form a wire path 44 that varies in only two-dimensions or, as presently illustrated, the relative depths of channels 82 may vary with respect to their respective surfaces 84 and 86 to form a wire path 44 that varies in three-dimensions. Once aligned with one another, the portions 78 and 80 may be coupled to one another through various techniques, including: ultrasonic welding; other welding techniques; bonding; use of one or more mechanical fasteners, such as rivets or clamps; or coupled in an alternative, suitable manner.

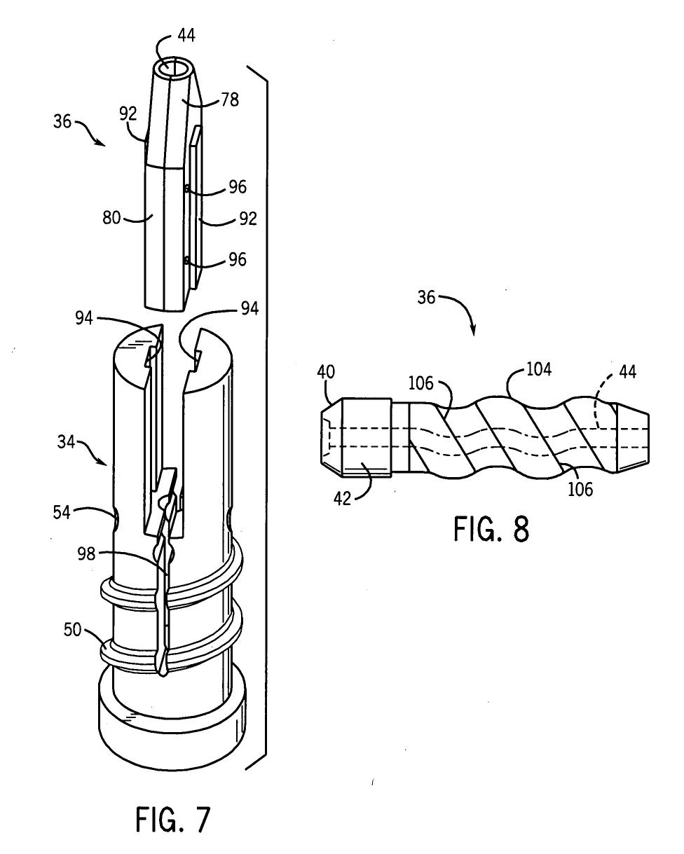

Additionally, while the presently illustrated embodiment includes portions 78 and 80 that cooperate to form a generally cylindrical contact tip, it will be appreciated that, in other embodiments, the contact tip body may have a different form and/or be composed of a different number of portions, such as a single, unitary body or a body having more than two mating portions. By way of example, a contact tip 36 having a generally rectangular profile is illustrated in FIG. 7. This exemplary contact tip 36 includes mating portions 78 and 80 that may be joined together to form a contact tip 36 having a non-linear wire path 44. In this embodiment, the contact tip 36 and diffuser 34 may also include various alignment features, such as one or more boss members 92 disposed on the contact tip 36 that may be received in mating slots 94 of the exemplary diffuser 34. The boss members 92 and the slots 94 cooperate with one another to facilitate alignment and securement of the contact tip 36 with respect to the diffuser 34. In one embodiment, upon insertion of the contact tip 36 within the diffuser 34, a nozzle may be fit over the contact tip to engage a threaded portion 50 of the exemplary diffuser 34. In such an embodiment, the nozzle may be configured to cooperate with a slot 98 formed in a diffuser 34 to apply an inwardly directed clamping force to the contact tip 36.

The portions 78 and 80 of FIG. 7 may be joined to one another through various suitable techniques, such as those described above with respect to FIGS. 5 and 6. For instance, in the illustrated embodiment, the portions 78 and 80 are coupled to one another via one or more rivets 96. In other embodiments, however, the portions 78 and 80 may be joined to one another via other techniques, including those described above.

In yet another embodiment, which is illustrated in FIG. 8, an exemplary contact tip 36 may include a non-linear wire path 44 formed through the application of an external force, such as that provided by a thread rolling-type process, to the exterior of the contact tip 36. In this embodiment, a contact tip having a linear wire path may be initially provided, which is then subjected to an external force (which may be applied via a pair of complimentary dies) that alters the linear wire path into the non-linear wire path 44. As noted above, in one embodiment, such force may be provided through a process of, or similar to, thread rolling, including a flat die rolling process, a cylindrical rolling process, a tri-roll process, or the like. As will be appreciated, in such a process, one or more dies are employed to apply a force to an exterior surface 104 of the contact tip 36. This force is translated through the contact tip 36 to the internal wire path and, with a sufficient force, results in both a rolling or undulating outer surface 104 and a non-linear wire path 44. Further, various embodiments of the contact tip 36 may include one or more heat dissipation features 106. These heat dissipation features 106 may take the form of knuckles, grooves, or various other features that promote convective or conductive heat dissipation from the contact tip 36. Such cooling features may be formed through a rolling process, such as that described with respect to FIG. 8, or through a variety of other manufacturing techniques, such as those described above with respect to FIGS. 5-7.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A contact tip for a welding torch, the contact tip comprising:
a contact tip body comprising an electrically conductive material; and
a non-linear passage extending through the body, wherein the non-linear passage is configured to receive a wire electrode and to facilitate electrical communication between the body and the wire electrode.

2. The contact tip of claim 1, wherein the body is a multi-piece body.

3. The contact tip of claim 2, wherein the body comprises first and second members configured to be coupled together along mating longitudinal surfaces of the first and second members.

4. The contact tip of claim 3, wherein the first and second members comprise channels formed in the respective mating longitudinal surfaces such that the channels define the non-linear passage when the first and second members are coupled together.

5. The contact tip of claim 3, wherein the first and second members comprise an alignment feature configured to cooperate with a mating feature of a welding torch diffuser.

6. The contact tip of claim 5, wherein the alignment feature is a boss member and the mating feature is a recess configured to receive the boss member.

7. The contact tip of claim 3, wherein the first and second members are coupled together via at least one rivet.

8. The contact tip of claim 3, wherein the first and second members are welded together.

9. The contact tip of claim 1, wherein the non-linear passage varies in two dimensions.

10. The contact tip of claim 1, wherein the non-linear passage varies in three dimensions.

11. The contact tip of claim 1, wherein the body comprises a substantially rectangular profile.

12. The contact tip of claim 1, wherein the body comprises a substantially cylindrical profile.

13. A contact tip for a welding torch, the contact tip comprising:
a contact tip body comprising an electrically conductive material; and
an internal bore formed in the contact tip body, wherein the internal bore defines a non-linear passage and is configured to facilitate passage of an electrical current applied to the body to a wire electrode disposed within the non-linear passage.

14. The contact tip of claim 13, wherein the non-linear passage varies in three dimensions.

15. A contact tip assembly for a welding torch, the contact tip assembly comprising:
a contact tip comprising a body that includes a longitudinal axis and a wire passage whose contours vary in proximity to the longitudinal axis;
a diffuser configured to receive the contact tip; and
a nozzle configured to be positioned about the contact tip and coupled to the diffuser.

16. The contact tip assembly of claim 15, wherein one of the contact tip or the diffuser comprises a boss member and the other of the contact tip or the diffuser comprises a recess configured to receive the boss member.

17. The contact tip assembly of claim 15, wherein the diffuser comprises a threaded portion configured to cooperate with a mating portion of the nozzle, wherein the diffuser is configured to exert a clamping force on the contact tip as the threaded portion of the diffuser is engaged by the mating portion of the nozzle.
